(19) United States
(12) Patent Application Publication
(10) Pub. No.: US 2020/0125643 A1
(43) Pub. Date: Apr. 23, 2020

(54) MOBILE TRANSLATION APPLICATION AND METHOD

(71) Applicant: JOSE RITO GUTIERREZ, COALINGA, CA (US)

(72) Inventor: JOSE RITO GUTIERREZ, COALINGA, CA (US)

(21) Appl. No.: 15/469,486

(22) Filed: Mar. 24, 2017

(51) Int. Cl. G06F 17/28; G10L 15/25; H04L 29/06

(52) U.S. Cl. CPC G06F 17/289; H04L 63/083; G10L 15/25

(57) ABSTRACT

A mobile translation application including a speech-to-speech module, a speech-to-text, a video-module, a map-module, a contacts-module, a profile-module, and an advertising-module. The speech-to-speech module includes translation capabilities to translate oral speech from a first-language to at least one second-language. The speech-to-text module includes translation capabilities to translate oral speech from the first-language to text in the at least one second-language. The video-module is useful for allowing users to view and display real-time video content recorded by a camera on a mobile device. All translations are conducted in real-time, and simultaneously. The mobile translation application allows each user to select a preferred language, and the mobile translation application is useful for providing the users with a platform for audio and visual communications from one location to another and in different languages.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of data processing: speech signal processing, linguistics, language translation, and audio compression/decompression and more specifically relates to multilingual or national language support.

### 2. Description of Related Art

Video conferencing is the act of communicating with remote individuals simultaneous by two-way video and audio transmissions. Video conferencing differs from video-type phone calls in that video conferencing is intended to serve a group conference (e.g., many individuals) or multiple locations rather than only two individuals. Early in the 2000's, video conferencing grew in popularity by the use of no cost internet applications and social media platforms that provide the users with software/applications such that users can conduct a video conference over an internet connection.

Technological developments by video conferencing programmers have changed the capabilities of video conferencing systems beyond the business boardroom. Video conferencing can now be used with mobile devices such as tablets or smart phones. With the introduction of relatively low cost, and high bandwidth broadband services, as well as computing processors and video compression algorithms, video conferencing is now used in business, education, medicine and media.

However, limitations still exist with common video conferencing. Today there are thousands of different languages and dialects spoken across the world. As such translators (which may be human or software-based) are often required when a video conference is conducted in different languages. Also, when there are multiple (e.g., more than two) languages spoken in multiple locations, multiple translators are often required at each remote location. Additionally, it may be beneficial for a person attending a video conference to both hear and read the translated language. Therefore a suitable solution is desired.

U.S. Pat. No. 8,583,431 to William N. Furman, John W. Nieto, and Marcelo De Risio relates to a communications system with speech-to-text conversion and associated methods. The described communications system includes a first communications device cooperating with a second communications device. The first communications device multiplexes a digital speech message and a corresponding text message into a multiplexed signal, and wirelessly transmits the multiplexed signal. The second communications device wirelessly receives the multiplexed signal, de-multiplexes the multiplexed signal digital into the speech message and the corresponding text message, decodes the speech message for an audio output transducer, and operates a text processor on the corresponding text message for display.

### BRIEF SUMMARY OF THE INVENTION

In view of the foregoing disadvantages inherent in the known multilingual or national language support art, the present disclosure provides a novel mobile translation application and method of use. The general purpose of the present disclosure, which will be described subsequently in greater detail, is to provide a mobile translation application and method of use.

A mobile translation application is disclosed herein. The mobile translation application includes a speech-to-speech module, a speech-to-text, a video-module, a map-module, a contacts-module, a profile-module, and an advertising-module. The speech-to-speech module module includes translation capabilities to translate oral speech from a first-language to at least one second-language. The speech-to-text module includes translation capabilities to translate oral speech from the first-language to text in the at least one second-language. As shown the present invention provides tangible results. The video-module is useful for allowing users to view and display real-time video content recorded by a camera on a mobile device (e.g., smart-phone, tablet computer, laptop computer, etc.). All translations are preferably conducted in real-time, and simultaneously.

Preferably, the mobile translation application allows each user to select a preferred language, and the mobile translation application is useful for providing the users with a platform for audio and visual communications from one location to another and in different languages. Preferably, the mobile translation application includes the ability to automatically recognize a first-language and at least one second-language.

The map-module useful for locating the users upon a map display related to a relative location of the users. Preferably, the map module further displays indicia of a preferred language of the location by displaying a flag or pin associated with the location (e.g., country flag, etc.). The contacts-module is useful for saving individual data related to the users and the profile-module includes personal and geographical information related to each of the users. The advertising-module may provide targeted advertising materials to at least one of the users based upon data contained within the profile-module as well as information contained within the contacts-module and map-module.

The mobile translation application preferably includes a user-log-in. The user-log-in may be accomplished by use of a user name and password, by a log-in for social media for social interchanges of communication, and/or log-in for social media used for work interchanges of communication.

Preferably, the application additionally includes a text-communication module such that users may communicate with one another without the need for oral speech. Also, the application includes the ability for users to conduct a public audio and video conversation such that any user may view and/or join in the conversation. Conversely, the application also includes the capabilities to conduct a private audio and video conversation such that only select users may join into select conversations.

According to another embodiment, a method of using a mobile translation application is also disclosed herein. The method of using a mobile translation application includes a first step, opening the mobile translation application upon a device; a second step, providing log-in information to the mobile translation application; a third step, selecting a first-language; a fourth step, providing oral speech in the first-language; a fifth step, translating the oral speech from the first-language into a second-language; a sixth step, receiving communications in the second-language; a seventh step, providing real-time video content to the mobile translation application; and an eighth step, receiving real-time video content upon the mobile translation application. It must be noted that each step is not required by each user, nor must all steps be performed in a particular order or sequence.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a mobile translation application, constructed and operative according to the teachings of the present disclosure.

FIG. 1 is a perspective view of the mobile translation application during an ‘in-use’ condition, according to an embodiment of the disclosure.

FIG. 2 is a diagram of the mobile translation application of FIG. 1, according to an embodiment of the present disclosure.

FIG. 3 is a front view of the indicia of a preferred language of the mobile translation application of FIG. 1, according to an embodiment of the present disclosure.

FIG. 4 is a front view of the user-log-in of FIG. 1, according to an embodiment of the present disclosure.

FIG. 5 is a flow diagram illustrating a method of using a mobile translation application, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to multilingual or national language support and more particularly to a mobile translation application and method of use as used to improve the capability of remote individuals to communicate across different languages.

Generally, a mobile translation application is able to recognize voice and translate the voice into both voice and/or text of another language simultaneously and in real-time. Such languages include most of the universal and commonly spoken languages around the world. The mobile translation application also includes real-time video capabilities. The application may be supported on multiple mobile and computing platforms.

The application is useful for business transactions and meetings such that the application may facilitate live meetings with users who speak different languages and/or are in different locations. Other uses include education where students may be in a remote location and/or speaking a language which differs from the educator, or for remote medical meetings, or court/legal proceedings. Further uses include social-type communications. The mobile translation application may utilize a camera, speaker, microphone, and/or keypad of an electronic device.

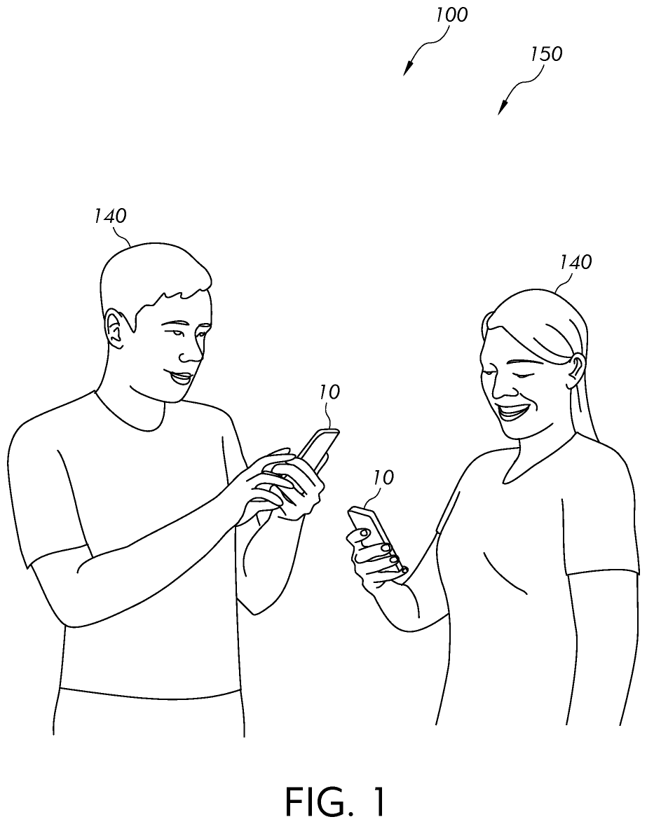

Referring now more specifically to the drawings by numerals of reference, there is shown in FIGS. 1-4, various views of a mobile translation application 100. FIG. 1 shows a mobile translation application 100 during an ‘in-use’ condition 150, according to an embodiment of the present disclosure. Here, the mobile translation application 100 may be beneficial for use by a user 140 to provide communication capabilities, including audio, video, and text translations, in real-time and across different languages by an electronic device. The electronic device may include smart-phone 10, a tablet-computer, a desktop-computer, a smart-television, or other suitable devices. Each user 140 may be able to select a preferred language, and the mobile translation application 100 may be useful for providing user 140 with a platform for audio and visual communications from one location to another.

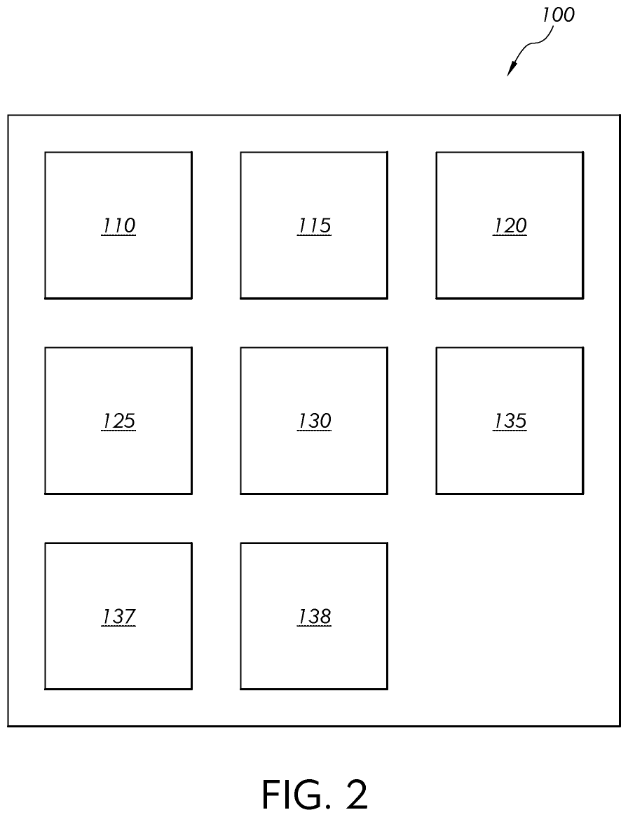

FIG. 2 shows the mobile translation application 100 of FIG. 1, according to an embodiment of the present disclosure. As above, the mobile translation application 100 may include speech-to-speech module 110, speech-to-text module 115, video-module 120, map-module 125, contacts-module 130, and profile-module 135. Embodiments may also include text-communication-module 138, and advertising-module 137.

Speech-to-speech module 110 may include translation capabilities to translate oral speech from a first-language to at least one second-language, and speech-to-text module 115 may include translation capabilities to translate oral speech from the first-language into text in at least one second-language. Video-module 120 may be useful for allowing user(s) 140 to view and display real-time video content recorded by a camera on a mobile device. Mobile translation application 100 may automatically recognize each of first-language and each of the at least one second-language, in some embodiments.

Also, map-module 125 may be useful for locating users upon a map display related to a relative location of users 140. Contacts-module 130 may be useful for saving individual data related to users 140, and profile-module 135 may include personal and geographical information related to each user 140.

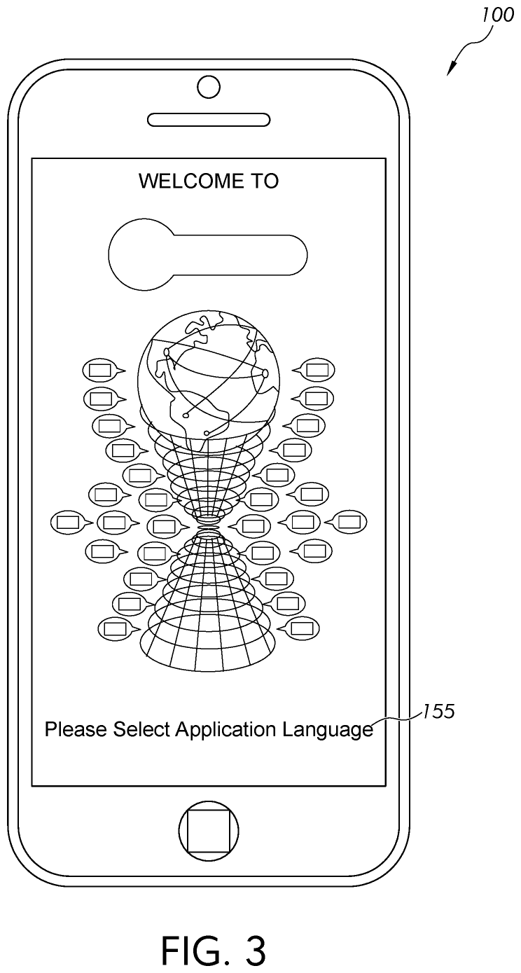

FIG. 3 is a front view of mobile translation application 100 of FIG. 1, according to an embodiment of the present disclosure. As shown, mobile translation application 100 may include map-module 125 which may display indicia of a preferred language 155 of the location by displaying a flag associated with the location. Embodiments may also include a pin or other indicia of the location and/or preferred language of user.

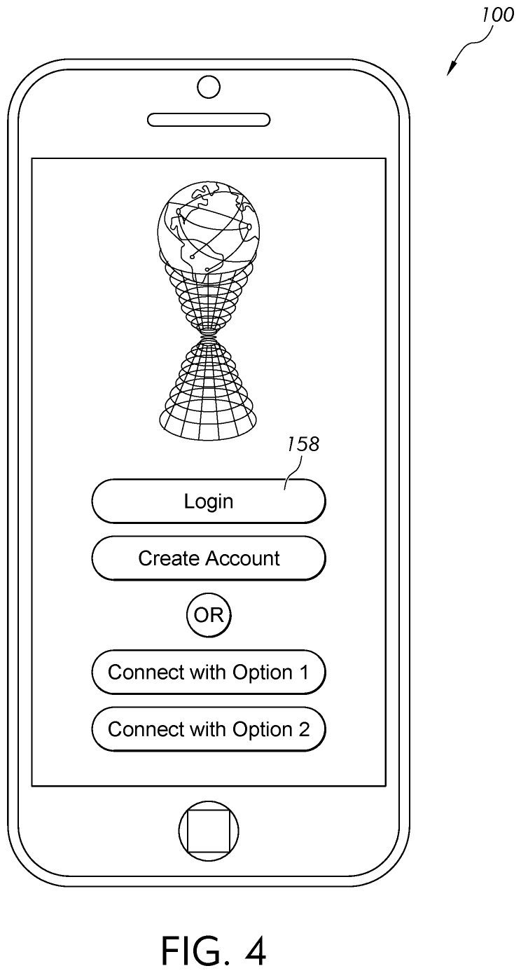

FIG. 4 is a front view of mobile translation application 100 of FIG. 1, according to an embodiment of the present disclosure. As shown, mobile translation application 100 may include and/or require user-log-in 158. User-log-in 158 may include a log-in for social media for social interchanges of communication, and/or may also include log-in for social media for social interchanges of communication. As shown, user-log-in 158 may also provide user 140 with an option to create an account.

Mobile translation application 100 may include the first-language and the at least one second-language which may be the same language, may include the first-language and the at least one second-language comprise different-languages, and/or the at least one second-language including the same language as the first-language and the at least one different language from the first-language.

Mobile translation application 100 may include the capabilities to conduct private audio and video conversations and may also include capabilities to conduct private audio and video conversations.

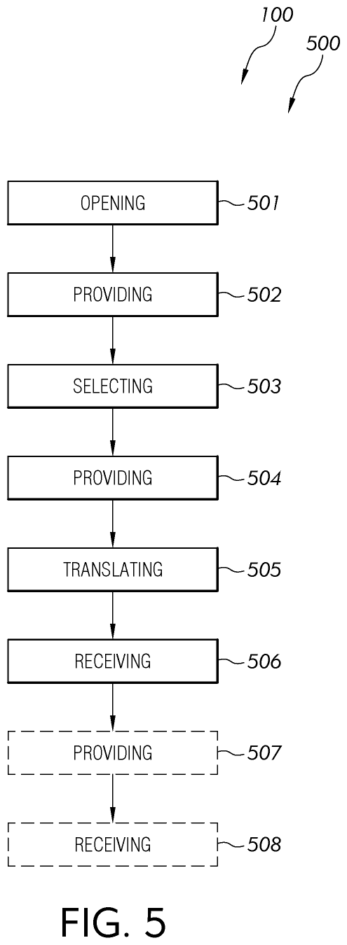

FIG. 5 is a flow diagram illustrating method of using 500 a mobile translation application 100, according to an embodiment of the present disclosure. In particular, method of using a mobile translation application 100 may include one or more components or features of mobile translation application 100 as described above. As illustrated, method of using 500 a mobile translation application 100 may include the steps of: step one 501, opening mobile translation application 100 upon a device; step two 502, providing log-in information to mobile translation application 100; step three 503, selecting a first-language; step four 504, providing oral speech in the first-language; step five 505, translating the oral speech from the first-language into a second-language; step six 506, receiving communications in the second-language; step seven 507, providing real-time video content to mobile translation application 100; and step eight 508, receiving real-time video content upon mobile translation application 100.

It should be noted that step seven 507 and step eight 508 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other method of using a mobile translation application (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1) (canceled)

2) (canceled)

3) (canceled)

4) (canceled)

5) (canceled)

6) (canceled)

7) (canceled)

8) A mobile translation system comprising:
a) a mobile electronic device comprising a camera wherein said mobile electronic device is selected from a class of devices limited to a smart-phone, or a tablet-computer;
b) a preferred-language-of-location indicia associated with a preferred-language-of-location;
c) a user-preferred-language indicia;
d) a user-location indicia;
e) a multilingual speech-to-speech module, structured and arranged with said mobile electronic device, comprising translation capabilities to translate oral speech from a first-language to at least one second-language, said first-language and said at least one second-language each comprising universal and commonly spoken languages;
f) a speech-to-text module structured and arranged with said mobile electronic device, comprising language translation capabilities to translate oral speech from said first-language to text in said at least one second-language;
g) a video-module, users to view and display real-time video content recorded by a camera on said mobile electronic device;
h) a map-module, for locating said users upon a map display related to a relative location of each said user, said map-module displaying at least one user-graphical-icon, each of said at least one user-graphical-icon corresponding to one of said users, each of said at least one user-graphical-icon carrying said user-preferred-language indicia corresponding to appropriate said user and also carrying said user-location indicia corresponding to appropriate said user, each of said at least one user-graphical-icon being anchored to a point on said map display corresponding to a reported location of said one of said users;
i) a contacts-module; structured and arranged with said mobile electronic device for saving individual data related to each said user;
j) a profile-module structured and arranged with said mobile electronic device, said profile-module including personal and geographical information related to each said user;
k) wherein said preferred-language-of-a-location indicia, said user-preferred-language indicia, and said user-location indicia are each structured and arranged with said mobile electronic device for each said user to select a preferred language associated with a location of each said user and further structured and arranged to automatically recognize said preferred language associated with a location of said user and translate that language into said user-preferred language; and
l) wherein said mobile translation system is useful for providing said users with a platform for audio and visual communications from one location to another;
m) wherein said system requires a user-log-in; and
n) wherein said user-log-in is accomplished via a log-in for social media used for work interchanges of communication.

9) (canceled)

10) (canceled)

11) (canceled)

12) (canceled)

13) (canceled)

14) (canceled)

15) (canceled)

16) (canceled)

17) (canceled)

18) (canceled)

19) (canceled)

20) A mobile translation system comprising:
a) a mobile electronic device comprising a camera wherein said mobile electronic device is selected from a class of devices limited to a smart-phone, or a tablet-computer;
b) a preferred-language-of-location indicia associated with a preferred-language-of-location;
c) a user-preferred-language indicia;
d) a user-location indicia;
e) a multilingual speech-to-speech module, structured and arranged with said mobile electronic device, comprising translation capabilities to translate oral speech from a first-language to at least one second-language, said first-language and said at least one second-language each comprising universal and commonly spoken languages;
f) a speech-to-text module structured and arranged with said mobile electronic device, comprising language translation capabilities to translate oral speech from said first-language to text in said at least one second-language;
g) a video-module enabling users to view and display real-time video content recorded by a camera on said mobile electronic device, the video-module allowing users to choose between public video-chats open to all other users and private video-chats limited to invited users;
h) a map-module, for locating said users upon a map display related to a relative location of each said user, said map-module being viewable on the mobile electronic device, said map-module displaying at least one user-graphical-icon, each of said at least one user-graphical-icon corresponding to one of said users, each of said at least one user-graphical-icon carrying said user-preferred-language indicia corresponding to appropriate said user and also carrying said user-location indicia corresponding to appropriate said user, each of said at least one user-graphical-icon being anchored to a point on said map display corresponding to a reported location of said one of said users;
i) a contacts-module; structured and arranged with said mobile electronic device for saving individual data related to each said user;
j) a profile-module structured and arranged with said mobile electronic device, said profile-module including personal and geographical information related to each said user;
k) wherein said preferred-language-of-a-location indicia, said user-preferred-language indicia, and said user-location indicia are each structured and arranged with said mobile electronic device for each said user to select a preferred language associated with a location of each said user and further structured and arranged to automatically recognize said preferred language associated with a location of said user and translate that language into said user-preferred language; and
l) wherein said mobile translation system is useful for providing said users with a platform for audio and visual communications from one location to another;
m) wherein said system requires a user-log-in; and
n) wherein said user-log-in is accomplished via a log-in for social media used for work interchanges of communication.
